(19) United States
(12) Patent Application Publication
(10) Pub. No.: US 2016/0100602 A1
(43) Pub. Date: Apr. 14, 2016

(54) CHEESE PORTION AND RELATED PRODUCTION METHOD

(71) Applicant: FROMAGERIES BEL, Paris (FR)

(72) Inventor: Alexandre VERNIER, NAVEIL (FR)

(21) Appl. No.: 14/894,195

(22) PCT Filed: Dec. 20, 2013
(86) PCT No.: PCT/EP2013/077849

§ 371 Date: Nov. 25, 2015

(30) Foreign Application Priority Data
May 27, 2013 (FR) 1354763

(51) Int. Cl. A23C 19/097; A23C 19/08; B65D 75/58; B65D 75/14; B65D 65/38; A23C 19/16; B65D 85/76

(52) U.S. Cl. CPC A23C 19/0973; A23C 19/166; A23C 19/08; B65D 85/76; B65D 75/14; B65D 65/38; B65D 75/58

(57) ABSTRACT

The cheese portion (38) includes: a wrapping sheet (40); and a cheese dose (88) wrapped in the sheet (40), the cheese (88) being hot-cast into the sheet (40). The sheet (40) includes at least one paper layer (401) having an internal face turned towards the cheese (88), at least one internal face being waterproof.

The invention generally relates to processed cheese either melted fresh or thermized fresh, packaged as individual portions from 5 to 30 g, and notably to the methods for manufacturing such cheese portions.

More specifically, the invention according to a first aspect relates to a portion of fresh, melted fresh or thermized fresh cheese of the type comprising:

a wrapping sheet having a basis weight comprised between 20 to 50 g/m² folded as a hollow shell, with a bottom and a side wall separated from the bottom by a first fold;

a wrapped cheese dose in the sheet, the cheese being hot poured between 70° C. and 85° C. in the liquid or viscous state in the shell;

a lid tightly sealed to the shell, the cheese portion comprising no dead volume.

### State of the Art

Lacquered aluminum packages used for packaging melted cheeses are known. These packages have many advantages. Aluminum provides the cheese with good protection towards the outer environment, since it forms a barrier layer notably towards gases and odors. It is economical, allows the use of a system facilitating the opening and allows high industrial throughput rates of the order of 90 to 130 counts/min.

However, aluminum requires a large amount of energy for its primary production, such that aluminum packages have unfavorable environmental performance. Moreover, aluminum in the thicknesses used for packages is very thin, and exhibits some fragility. It may be torn or perforates when it is subject to excessive mechanical stresses, for example under difficult transport conditions.

Plastic packages are also known for melted cheese, melted fresh cheese portions as described in patent WO 2009/092966. Plastic has a more interesting environmental performance than aluminum, notably as regards primary energy consumption and impact on the greenhouse effect. But its total lack of folding (or dead-fold) memory strongly complicates its industrialization imposing heating of the material during shaping and in fact limiting the throughput rates of machines.

Moreover, traditional cheeses are conventionally packaged in wrapping papers in solid form. The solid nature of these cheeses upon packaging makes the folding of the sheet around the cheese easy. The packaging method of this type of cheese is very different from that of the present invention.

Indeed, for this type of packaging, as traditional cheeses are in a solid state upon their packaging, the product plays the role of a piston and of a support upon folding: The product and the sheet are pushed into a folding chamber. The packaging is folded back on the cheese by bearing upon the latter, without any need of a mechanical counterpart. Generally the packaging is then stuck by a label by pressing on the product, or sealed on itself. In this case, the systems for folding and maintaining the folding which may press on the product, the shaping and the closing of the packaging are greatly facilitated as compared with the application described in the invention.

A paper packaging as described in GB 496,871 including a coating protecting the paper from water and allowing sealing by pressure or heating is also known from the state of the art. The coating used in this patent, based on wax and rubber, is not adapted to the packaging of a hot product, not guaranteeing the inertia of the packaging in the present regulatory background. It is not possible to obtain preservation for several months, as desired, with the described coating, the migrations related to the coating may alter the taste of the cheese. Further, the described application deals with products of 230 g and more. Making the folding is much more complex on small size portions with a high industrial throughput rate.

### Technical Problem to be Solved

Thus, the technical problem to be solved by the present invention is to find a wrap for packaging a cheese portion which may be adapted to existing industrial machines which has better environmental performance while remaining economical and having sufficient mechanical properties for withstanding an industrial throughput rate of 90 to 130 stroke/min, and under difficult transport conditions of the large export type, while being easy to open and allowing a shelf life of several months.

### SUMMARY OF THE INVENTION

For this purpose, the invention deals with a portion of fresh, fresh melted or fresh thermized cheese of the aforementioned type, characterized in that the sheet does not include any aluminum layer, the sheet including at least one paper layer having an internal face turned towards the cheese and an external face opposite to the cheese, a low temperature sealing layer, at least one waterproof layer interposed between the internal face of the paper layer and the sealing layer, and at least one external waterproof layer covering the external face of the paper layer.

### Definitions

### Portion:

Within the scope of the present invention, by “portion” is meant an amount of cheese in a packaging wrap for which the weight is comprised between 5 and 30 g.

### Paper:

The term of paper is defined as being a material appearing as a sheet consisting of entangled cellulose fibers which may contain additives for ensuring the cohesion of the sheet and the surface condition, additives conventionally used in the making of paper such as mineral fillers, starch, adhesives etc. . . . , there exists a large variety of paper changing by the nature of their fibers, additives and mechanical treatments which they may undergo. Within the scope of the invention, the basis weight is comprised between 20 and 50 g/m², preferably between 30 and 40 g/m². Preferred grades include short fibers so as to have good tearing, having been subject to not much mechanical treatment in order to keep a large hand (thickness/basis weight ratio) for the quality of the folding, a surface coating for the external aspect and printability, with a thickness of less than 150 μm, and preferentially comprised between 20 and 50 μm, and compatibility with use in the agro-feed industry.

### Waterproof:

By waterproof is meant here the fact that the internal face has low permeability to liquid water and/or to steam, of less than 500 g.μm/m².24 h.atm, preferably less than 100 g.μm/m².24 h.atm, still preferably less than 50 g.μm/m².24 h.atm. Thus, the paper is protected from water in liquid or vapor form from the cheese, which limits the risk that the paper disintegrates under the effect of water absorption. The water permeability of an external face of the sheet opposite to the cheese is greater than the permeability of the internal face, in order to facilitate discharge of the humidity from the cheese.

### Advantages of the Invention

The use of a sheet comprising at least one paper layer gives the possibility of improving the environmental performance of the method. The paper is a replacement for the aluminum layer. Thus, the sheet does not include any aluminum layer.

Moreover, the paper of the invention should have good folding memory (dead fold). Accordingly, the sheet is thus easy to fold, which is important for forming the shell into which the liquid and hot cheese will be cast. The folding is also stable over time separating the shaping and the dosage of the cheese. The sheet of the present invention is stable in temperature (no deformation or hole in contact with the hot cheese). A plastic sheet as described in patent WO 2009/092966 does not have the same qualities, since it has to be heated for memorizing a fold.

### Packaged Cheeses

The invention typically applies to melted cheese. It also applies to fresh cheese, fresh melted cheese and to all cheese specialties having fluid, semi-liquid or liquid consistency upon casting. By cheese or cheese specialty are meant here products from the transformation of milk into cheese, regardless of whether these products totally consist of a raw material of dairy origin or mixed with raw materials of plant origin (protein, fat, cereal, etc.).

Typically, the packaged cheese of the present invention is inert, i.e. it does not ripen and does not release any gas after packaging in the wrapping sheet, which allows the making of a leak-proof wrap for these cheeses.

These cheeses are cast under hot conditions, i.e. typically between 70° C. and 85° C. Indeed, if the cheese is cast under cold conditions, it has a texture which does not allow it to fill the wrap. In order to guarantee filling, a viscous liquid product is needed, which flows and fills each nook of the wrap. The temperature of the cheese is also used for assisting with sealing: When the lid is folded with the shell, an intimate contact is created between both of these elements. A sealing iron will then be pressed on the top of the wrap. This iron provides heat on the top. Heating the cheese from underneath is necessary: On a cold product, the heat losses by the product during the sealing would not give the possibility of attaining the temperature required for sealing. The heat of the cheese also has the advantage of providing a certain level of sanitization of the wrap.

### Advantages of the Invention for Cheeses

Thus, with the invention it is possible to obtain cleanliness which tends towards sterility, which imparts to the cheese portion a long shelf life without any microbial development.

The fact that the sheet is folded as a hollow shell is particularly advantageous for packaging a soft cheese under hot conditions. Such a cheese does not stand alone under hot conditions, during the packaging operations. The cheese remains soft after cooling, but is supported. During the dosage, a container is needed for receiving the cheese and for allowing it to assume the final desired form. After cooling, the fact that the cheese is tightly fitted in the wrap (no dead space or volume between the cheese and the wrap sheet) gives the possibility of limiting the deformations of the wrap and of the cheese. The lack of a head space also plays a positive role on the preservation of the product, notably limiting the risks of oxidation or syneresis.

By means of the present invention, the wrapped cheese has optimum preservation properties. It may be kept for several months, under out-of-cold conditions for some of them.

### Sealing and Sealing Layer:

In a more detailed way, the wrapping sheet should include a layer allowing the shell to be sealed on itself. This layer is a layer of polymers, or a layer of lacquer or a layer of varnish.

The melting temperature of the sealing layer should be less than 90° C., preferably less than 80° C., which gives the possibility of ensuring sealing while being assisted by the heat released by the cheese. This coating should be applied on the internal face of the paper layer of the shell, and on the external face of the lid (in contact with the shell). Alternatively, as illustrated in FIG. 7, the coating providing the seal is applied on the internal face of the lid. The external face of the lid in this case may preferably be sealed on itself.

### Water Impervious Layers:

The sheet should also include a waterproof layer between the sealing layer and the paper layer. This layer has the function of protecting the paper from the humidity of the product and of avoiding degradation of the mechanical properties of the paper over time, and also avoiding the loss of water of the product in order to preserve its organoleptic properties and notably its texture.

The waterproof external layer has the function of protecting the paper from the outdoor humidity and of avoiding degradation of the mechanical properties of the paper over time.

The typical structure of the wrapping sheet from the inside to the outside is therefore:

Cheese/low temperature sealing layer/waterproof layer/paper layer/optionally print/waterproof external layer.

Alternatively, the waterproof layer and the sealing layer are a single and same layer consisting of a same material. The sealing layer may be made at the same time as the waterproof layer when the latter simultaneously has the double property of a barrier to humidity and of a low temperature seal. Moreover, the sheet may include other layers between the sealing layer and the internal face of the paper layer.

Alternatively, the wrapping sheet comprises other layers between the external face of the paper layer and the waterproof external layer.

Treatments with a Sealant:

Advantageously, the waterproof layer, interposed between the internal face and the sealing layer, comprises at least one of the following layers: a waterproof lacquer layer, a waterproof varnish layer, a plastic material layer.

The sheet does not comprise any wax layer.

This waterproof layer gives the possibility of making the internal face waterproof.

The seal of the internal side of the paper layer may be reinforced by various means.

For example, the internal face of the paper layer may bear a chemical graft of a fatty acid.

Further, the internal face of the paper layer may be subject to a chemical sealing surface treatment, for example with sulfuric acid, with a product based on silicone or with a fluoride. It may also be subject to a mechanical sealing treatment, by embossing and/or by calendering.

Further, the paper layer may undergo a sealing treatment in the bulk, and contain a product based on silicone, and/or a fluoride dispersed in the paper in a mass proportion relatively to the paper, selected so as to make the paper layer waterproof.

These different sealing treatments may be combined together.

The treatment in the bulk is particularly suitable for the lid, the edge of which may have the paper material in direct contact with the cheese.

On the external side, the waterproof external layer comprises at least one from among a waterproof lacquer layer, a waterproof varnish, a plastic material layer.

### The Paper Layer:

In the state of the art, it is current practice to use a paper sheet with a large basis weight of the order of 80 g/m² in order to obtain optimum folding. However, in order to obtain a real environmental advantage and to preserve the economical benefit of the material as compared with solutions based on aluminum, the paper should be thin, i.e. the paper basis weight should be comprised between 20 to 50 g/m², preferentially between 30 and 40 g/m², which generates technical folding, mechanical strength, preservation problems.

The paper material should have an optimum dead-fold. For this, it is necessary to operate with paper materials having a large thickness (typically comprised between 20 and 50 μm, but less than 150 μm) for a given basis weight, i.e. materials with a large hand (thickness-over-basis-weight ratio), as opposed to not very thick materials which have been calendered.

In order to allow the formation of a shell, the material should be transformed with adapted mechanization in order to preserve its shape during the various steps of the manufacturing method.

### Dead-Fold/Relaxation:

Advantageously, the sidewall, after folding the sheet and before casting the cheese into the shell, forms with the bottom a predetermined angle, with possible relaxation outwards of 15° at the most, because the sheet has weakening along at least one line intended to form the first fold, and/or because the first fold has been subject to crushing. The predetermined angle for example substantially has the value of 90°.

In other words, the sidewall forms with the bottom an angle comprised between the predetermined angle and the predetermined angle +15°. By relaxation is meant here the fact that after folding, the sheet tends to be partly unfolded. The first folds partially open. In the invention, the use of a sheet with a paper layer gives the possibility of limiting the relaxation, notably as compared with the plastic materials described for making such a portion in WO 2004/052753A1. This facilitates the manufacturing of the cheese portion, notably the handling and the transfer of the shell in the production line. The relaxation is preferably less than 10° and even preferably less than 5°. Obtaining this characteristic is obtained by the use of a paper having a basis weight comprised between 20 and 50 g/m² covered by layers of small thicknesses as described below, for limiting the degradation of the dead-fold.

### Paper Proportion in the Material:

Advantageously, the sheet has a first thickness, the paper layer having a second thickness at least greater than 30%, and advantageously greater than 50% of the first thickness. In other words, the paper represents at least 30% of the thickness of the material and ideally more than 50% of the total thickness (paper with the inner layers (sealing layer and waterproof layer) and outer layers). This gives the possibility of imparting to the sheet good shape memory. Typically, the thickness of the paper sheet is comprised between 20 and 40 μm, the layers applied on the inner side between 6 and 12 μm, the applied layers on the outer side between 2 and 6 μm. The outer protection is ideally ensured by a varnish of a few microns not altering the mechanical properties of the paper material.

This means in other words that the sheet does not include too much plastic. The lower the plastic/paper ratio (the more paper there is as compared with the plastic), the more the material will have a dead-fold of interest for the application, the greater is this ratio (more there is plastic relatively to the paper), the more the material is nervose and has poor dead-fold and will tend to open after the shaping step.

### Opening System:

Advantageously, the portion includes an opening system arranged for causing the opening of the wrapping sheet as soon as the opening system is acted upon by a user. The opening of the cheese portion is facilitated.

The opening system is of any suitable type: a resistant material strip or a thread integrated into the portion and giving the possibility of forcing the tearing of the sheet or of the seal, weakenings of the sheet delimiting an area which may be manually torn by the user, the use of a sealing material providing peelability after cooling etc. The preferentially used solution is the use of a tear strip in a resistant material, typically a PET film, or of another resistant plastic material, stuck on the material at the desired location for the tearing. This type of system is also called a tear-strip, or Tircel (registered trademark of Rexor).

### Influence of the Paper on the Quality of the Tearing:

The paper should be adapted for allowing good quality tearing. The selection is made by a tearing test in which the sample of paper material is folded over the edge of a plastic plank, an adhesive strip is stuck inside the paper material, the paper material is attached on the sides of the plank, and the adhesive strip is pulled. By observing the edge of the tear, it is possible to estimate whether the paper material is suitable for such an opening method. Obtaining a straight tear is important for preserving satisfactory opening functionality, and its aspect is important for acceptance of the material by the consumer.

Thus, a paper with short cellulose fibers is preferentially selected for the application, the geometry is adapted so that the tear preferentially is achieved parallel to the machine direction, and materials are selected for the layers covering the paper layer which have low stretch upon tearing, or oriented and allowing a clean tear.

The other Layers of the Wrapping Sheet:

The wrapping sheet alternatively includes, in addition to the paper layer, to the sealing layer, to the waterproof layer and to the waterproof external layer, various additional layers provided for increasing waterproofness, imperviousness to odors, to gases, in order to improve the seal of the sheet on itself, for imparting mechanical strength to the sheet, or for decorating the sheet, this list not being limiting.

### Other Characteristics:

The cheese portion may also have one or several of the characteristics below, considered individually or according to all the technically possible combinations.

### Casting Temperature

Advantageously, the cheese is cast into the shell at a casting temperature, the sheet comprising a sealing layer sealing the shell to the lid and having a melting temperature comprised between the casting temperature plus 10° and the casting temperature minus 10°.

Thus, the heat released by the cheese contributes to sealing the shell and the lid.

### The Lid

According to a first embodiment, the lid is an area of the sheet. It is made with the sheet in the same material.

According to a second embodiment, the lid is not an area of the sheet and includes at least one paper layer having an internal face turned towards cheese, at least the internal face being waterproof. It is not made with the shell in the same material.

In this second embodiment, the lid advantageously has the following structure:

Cheese/waterproof layer/paper layer/optionally print/waterproof external layer/sealing layer.

The paper layer, the sealing layer, the waterproof layer and the waterproof external layer advantageously have the characteristics described above, for the wrapping sheet. The lid advantageously undergoes the sealing treatments described in the paragraph above.

In both embodiments, the lid gives the possibility of covering the cheese and provides a surface for sealing the portion (shell-lid). The second embodiment requires less material. Consequently, it generates less folds, making the sealing more complex and the seal more reliable.

### Manufacturing Method

### Description of the Steps

According to a second aspect, the invention deals with a method for manufacturing a cheese portion having the characteristics above, the method comprising at least:

a step for supplying the wrapping sheet;

a step for folding the sheet, during which at least one first fold is formed in the sheet, the latter adopting the shape of a hollow shell with a bottom and a sidewall separated from the bottom by the first fold;

a step for filling the shell, by casting the cheese into said shell,

the method further comprising a step for weakening the sheet along at least one line intended to form the first fold, and/or a squeezing of at least the first fold.

### Weakening/Squeezing for the Folding

The weakening and/or the squeezing are produced without heating the sheet.

The shape memory of the paper layer is clearly not as good as the shape memory of an aluminum layer. In other words, when an aluminum layer is folded, it spontaneously keeps its shape and does not tend to reopen. On the contrary, when a paper layer is folded, it will tend to reopen at least partly. By adding a step for weakening the folding or squeezing lines of the folds, it is possible to compensate for the fact that the paper layer has a shape memory not as good as an aluminum layer. The weakening of the sheet along the folding lines, or the squeezing of the folds, has the effect of breaking the structure of the paper layer and of attaching the fold. The shape memory of the paper is nevertheless much greater than that of plastic, so that it is possible to achieve the folding operation with equipment close to the one used for an aluminum sheet, which is not the case for sheets which are in majority plastic.

It is thus possible to attach the fold without providing heat, which considerably simplifies the manufacturing method. By limiting resorting to heating of the material for its shaping, it is possible to access production throughput rates similar to that obtained with the aluminum material, which is not the case with plastic material. Producing these folds at a high rate nevertheless requires the use of suitable methods as described in the invention.

By weakening the sheet is meant here the application to the sheet of a treatment giving the possibility of reducing the stiffness of the sheet along the line(s) intended to form the first fold(s). This weakening notably gives the possibility of breaking the fibers of the paper layer along said lines. The result of this is that the folding of the sheet along said line(s) is facilitated, and the memory upon folding the sheet is improved.

The weakening may be made by applying a mechanical treatment to the sheet or any other type of suitable treatment. For example, the weakening is grooving obtained by applying a grooving thread along the folding line intended to form the first fold. Alternatively, the weakening is obtained by moving a roller along the folding line, or by a laser heat treatment giving the possibility of removing a portion of the material in order to generate a fragile area, etc.

By squeezing a fold is meant here an operation consisting of pinching the fold, by acting upon the areas of the sheet immediately located on either side of the fold towards each other, with significant pressure. This squeezing substantially has the same effect as the weakening, i.e. it allows breaking of the structure of the sheet along the fold. In particular, the fibers integrated into the paper layer are “broken”, which has the effect of weakening the structure of the sheet. This gives the possibility of improving the memory upon folding the sheet.

Thus, the folding operations are mechanical, and good folding is obtained by strongly pressing the folds or by applying a strong mechanical stress during the formation. In order to complete the maintaining of the shape of the shell, additional systems are used of the adhesive bonding type on the outside of the shell, and/or a system for holding it in the cell with a vacuum.

### The First Folds

The folding step leads to the formation of one or several first folds, depending on the shape of the cheese portion, and notably on the shape of the bottom. When the bottom is triangular, three first folds are formed by folding. For a circular bottom, a single first fold is formed. It is also possible to form two first folds, four first folds or any number of first folds.

### The Second Folds

According to an alternative embodiment, during the folding step, at least one second fold is formed in the sheet, the second fold dividing the sidewall into several faces, the method comprising a step for weakening the sheet along at least one line intended to form the second fold, and/or squeezing of at least the second fold. The weakening or the squeezing is preferably produced without heating the sheet.

The technical advantages are the same as those described relatively to the formation of the first fold, i.e. facilitating the folding of the sheet and improving the memory upon folding the sheet.

The sidewall may include any number of second folds, depending on the shape of the cheese portion. When the sidewall is cylindrical, it includes a large number of second folds. When the bottom is triangular, the sidewall includes three second folds. When the bottom is square or rectangular, the sidewall includes four second folds. The sidewall may also include two second folds or more than four second folds.

### Formation of the Folds by Passing in a Chimney

According to an alternative embodiment, the folding step of the sheet is achieved by pushing the sheet by means of a piston through a folding chimney, the piston having a front face and a side surface, the front face being in contact with the sheet and having a shape identical to that of the bottom, the chimney having a plurality of blades arranged for producing the first and second folds and pushing back the sidewall of the shell against the side surface of the piston.

Such a folding method is particularly well adapted in the present case, since it gives the possibility of controlling the squeezing of the first and second folds, by adjusting distance of the blades relatively to each other, or relatively to the piston.

The arrangement of the chimney depends on the shape of the cheese portion. Such chimneys are known and will not be described in detail here.

### Weakening for Forming the First Folds

According to an alternative embodiment, the weakening is produced by pinching the sheet between a protruding fillet around the front face of the piston and a pad. Grooving of the sheet is thus conveniently achieved at the lines intended for forming the first folds.

In this case, the pad advantageously includes a surface in an elastic material against which the thread is applied. This allows the thread to sink into the elastic material, and therefore increase the applied stress by the thread along the folding lines.

Moreover, the pad may include a hollow groove in which the thread will be engaged. As earlier, this gives the possibility of increasing the applied stress to the folding line by the thread.

### Squeezing of the First Folds

According to an alternative embodiment, the squeezing of the first fold is achieved by acting upon the sheet by means of the piston inside a cell.

The cell typically has a conjugate shape of that of the hollow shell. By strongly acting upon the sheet by means of the piston inside this cell, the bottom of the hollow shell is flattened against the bottom of the cell, and the sidewall of the hollow shell against the wall of the cell. This has the effect of achieving controlled squeezing of the first folds. The cells are typically made in a carrousel which displaces the shell between different stations each corresponding to a step of the method. Linear displacement kinematics of the cells on a line is also possible, the line displacing the cell containing the shell between the various stations each corresponding to a step of the method.

In this case, the squeezing of the first fold is advantageously damped by a spring interposed between the piston and an actuator provided for displacing the pistons, or between a pad forming the bottom of the cell and a fixed support.

This gives the possibility of avoiding all the problems of mechanical adjustment, notably adjustment of the stroke of the piston. In the first alternative embodiment, the spring is interposed between the actuator provided for the displacement of the piston and the actual piston. Thus, when the piston comes into contact with the bottom of the cell, additional displacement of the actuator is expressed by compression of the spring. Alternatively, the cell has a movable bottom, mounted on a fixed support via the spring. In other words, the bottom of the cell may move with respect to the wall of the cell, and notably sink in against the return force of the spring.

Alternatively, the piston is bound to a vertical rod arresting and bearing upon an eccentric wheel forming a cam. During half of the rotation of the wheel, when the supporting point of the rod moves from a relatively larger radius towards a relatively smaller radius, the piston moves down under its own weight. The travel of the cam is longer than necessary for displacing the piston as far as the bottom of the cell, the piston stopping its motion earlier by contact with the bottom of the cell. During the other half of the rotation of the wheel, when the supporting point of the rod moves from a relatively smaller radius towards a relatively larger radius, the piston is pushed back upwards by the cam.

Alternatively, the piston is displaced by a pneumatic actuator. The movement of the piston is stopped when the latter comes into contact with the bottom of the cell. If this contacting occurs before the end of travel of pneumatic actuator, the force applied by the piston on the bottom of the cell is controlled via the air pressure inside the pneumatic actuator and by the diameter of the actuator.

### Maintaining the Shell on the Piston by Evacuation

According to an alternative embodiment, the bottom of the shell is maintained flattened against the front face of the piston by evacuation through said front face. Thus, the sheet is intimately flattened against the front face of the front piston and during the step for folding the sheet. The sheet cannot move away from the piston at the area which will become the bottom of the shell. Entering the sheet into the chimney folds back the sidewall of the hollow shell against the side surface of the piston. As the sheet is better flattened against the piston, the first and second folds are of better quality.

For evacuation, a plurality of holes is provided in the front face of the piston, these holes being connected to a suction device such as a vacuum pump.

### Squeezing the Second Folds

According to an alternative embodiment, the squeezing of the second fold is achieved by pinching between blades of the chimney and/or by pinching between the blades of the chimney and the piston.

Indeed, unlike aluminum which risks being perforated or torn by too strong friction during the folding, a paper layer may undergo this type of friction without any damage. It is thus possible to provide reduced plays between the blades in the folding chimney and between the piston and the chimney. These reduced plays lead to pinching of the second fold(s) during the passing of the sheet into the chimney.

According to an alternative embodiment, the squeezing of the second fold is achieved by a friction part bound to the chimney through an elastic member urging said friction part against the piston, the friction part for example being a roller.

The squeezing of the second fold by the friction part comes in addition or instead of the squeezing of the second fold between the blades of the chimney and/or between the blades of the chimney and of the piston.

Thus, when the piston is moved through the chimney, the second folds are made in the sheet, these second folds being squeezed between the friction part and the piston under the effect of the return force of the elastic member when the piston exits the chimney. The friction part is typically a polymeric part having a surface condition adapted so as not to damage the sheet. The surface of the friction part coming into contact with the sheet is of a suitable shape for producing the squeezing. When the friction part is a roller, it is bound to the elastic member via a pivot connection allowing the roller to role against the sheet by achieving squeezing of the second fold. Alternatively, the friction part is a roller rigidly attached to the elastic member, or is a part having another shape. The elastic member is for example a coil spring, or a blade or any other type of suitable spring.

### Maintaining the Shell in the Cell by Evacuation

According to an alternative embodiment, the shell exiting the chimney is deposited in a cell, the sidewall of the shell being maintained flattened against the cell by evacuation through a wall of the cell. This method gives the possibility of compensating for the dead-fold of less good quality than for an aluminum sheet.

Typically, the step for filling the shell by casting the cheese is carried out with the shell placed in the cell. Thus, between the moment when the shell is deposited in the cell and the moment when the shell is filled with the cheese, the sidewall of the shell is maintained in position in the cell by evacuation. Notably, this prevents the first and second folds from unfolding. To do this, a plurality of holes is provided in the wall of the cell, connected to a suction member such as a vacuum pump.

### External Adhesive for Maintaining the Second Folds

According to an alternative embodiment, the sheet includes an adhesive on marked areas intended to form the second folds. This method gives the possibility of compensating for the dead-fold of less good quality than for an aluminum sheet.

The adhesive is placed on the external face of the sheet, in order to avoid any contact with the cheese. The adhesive is for example an adhesive product which may be mechanically reactivated by pressing on the sheet. The adhesive is for example:

a cold adhesive (cold-seal);

an adhesive known as a hot-melt adhesive, preferably a hot-melt adhesive which remains tacky at the surface even at room temperature (residual cold tack);

another adhesive of the glue or varnish type, which remains tacky under cold conditions and thus allows adhesion between two surfaces put into contact and pressed against each other.

The adhesive is deposited inside the second folds so as to maintain the latter flattened at the shell. This limits the risk of opening of the portion by a spring effect of the sheet.

The adhesive may be deposited on the sheet in the line for manufacturing the portion, before the shaping of the shell. This has the advantage of avoiding any risk of sticking during the unwinding of the sheet on the upstream side of the production line.

Alternatively, the adhesive may be deposited on the sheet at the provider of the sheet. This has the advantage of simplifying the line for manufacturing the portion.

### Third Folds and Lid

According to an alternative embodiment, the method comprises:
a step for depositing a lid on the cheese;
a step for folding a free edge of the shell towards the lid, at least generating a third fold between the sidewall of the shell and said free edge of the shell;

the method comprising a step for weakening the sheet along at least one line intended to form at least the third fold, and/or squeezing of at least the third fold, the weakening and/or the squeezing being achieved without any heating.

These steps typically occur after the step for filling the shell. The number of third folds depends on the shape of the cheese portion. The folding step may lead to the formation of a third fold, of two third folds, of three third folds, or of any number of third folds.

The lid is intended to close the cheese portion on a side opposite to the bottom of the shell. For example it is made in a sheet substantially of the same structure as the shell. Alternatively, the structure of the sheet forming the lid is slightly different from that forming the shell, in order to allow sealing between the internal face of the shell and the external face of the lid. In this case, the external side of the shell includes a suitable layer for sliding on the mechanical equipment for manufacturing and protecting the paper from the external medium. The internal side of the shell includes a suitable layer for contact with the cheese and sealing with the lid.

The weakening and the squeezing of the third fold(s) has the same advantages as those described relatively to the first and second folds.

Typically, the step for folding the free edge of the shell towards the lid is achieved by flattening an internal finger against the lid, a free end of the internal finger arriving in close proximity to the free edge of the shell, and by moving an external finger parallel to a free surface of the cheese from the outside to the inside of the shell, the squeezing of the third fold being achieved by pinching between the internal finger and the external finger.

Thus, the internal finger is placed towards the inside of the shell relatively to the free edge, and the external finger is placed towards the outside of the shell relatively to the free edge. The displacement of the external finger leads to folding back the free edge towards the internal finger. The play between the internal finger and the external finger is reduced, and is selected for achieving squeezing of the third fold. This is feasible for a sheet containing a paper layer. This is not feasible for a sheet containing an aluminum layer, since the aluminum would risk being damaged or torn during the movement of the external finger.

### Sealing the Lid

According to an alternative embodiment, the method comprises a step for sealing the free edge of the shell with the lid, the free edge being maintained in position between the step for folding towards the lid and the sealing step.

The sealing step is typically achieved thermally, the sheet and the lid including hot-melt adhesive layers placed in contact against each other and heated so as to adhere with each other. In any case, it is necessary to flatten the free edge against the lid during the sealing step. This is obtained by moving down a pressure member which will urge the free edge of the shell against the lid. By maintaining in position the free edge between the folding step towards the lid and the sealing step ensures that this free edge may be more easily caught by the pressure member. In the absence of such maintaining, the third fold may open up, and the free edge may unfold by returning to its initial position. The free edge is for example maintained in position by a set of flaps arranged like a still camera diaphragm. The flaps are all movable between a position relatively closer to the center of the lid, and a position relatively further away from the center of the lid. The flaps are maintained in the close position between the folding step and the sealing step, so as to maintain the free edge in position. The flaps are moved towards their remote position when the pressure member is brought closer to them.

The pressure member is for example an iron, intended to heat the free edge of the sheet in order to achieve sealing.

Weakening of the Folds upon Cutting

According to an alternative embodiment, the weakening is achieved before the step for folding the sheet.

This weakening is achieved along the lines intended to form the first folds and/or the second folds and/or the third folds. It may be achieved along the folding lines of a single one of the three types of folds, or of two of the three types of folds, or of the three types of folds. This weakening is typically achieved before or during the cutting step. Indeed, the sheet is typically cut out into a part with a large length, for example a spool. Typically, the tool for cutting the sheet includes grooving fillets located, set back from the blades, and a support arranged so that upon cutting the sheet, the grooving fillets flatten said sheet against the support. Thus, upon cutting the sheet, the latter receives a mechanical urge along the grooving fillets, at the folding lines.

Alternatively, the weakening is achieved after the cutting step or before the step for cutting the sheet.

### FIGURES

Other features and advantages of the invention will become apparent from the detailed description which is given thereof below, as an indication and also as a limitation, with reference to the appended figures, wherein:

FIG. 1 is a flowchart illustrating the main steps of the method;

FIGS. 2 and 3 are perspective views of the cheese portion obtained by means of the manufacturing method;

FIG. 4 is a simplified schematic illustration of the sub-steps for cutting the sheet;

FIG. 5 is a simplified schematic illustration of the piston, of the folding chimney and of a cell, these various elements being applied during the step for folding the sheet;

FIG. 6 is a simplified schematic illustration of the step for filling the shell;

FIG. 7 is a simplified schematic illustration of the step for folding the free edge of the shell;

FIG. 8 is a schematic illustration of a sheet before folding, adapted for a triangular geometry portion;

FIG. 9 is a simplified schematic illustration of the piston and of the pad used in the folding step, for an alternative embodiment of the invention wherein the piston bears a grooving fillet;

FIG. 10 is a simplified schematic illustration of the piston used in the folding step, for an alternative embodiment wherein the piston bears suction orifices in addition to the grooving fillet;

FIGS. 11 and 12 are simplified schematic illustrations of the piston and of the pad used in the folding step, for two alternative embodiments of the invention wherein the movement of the piston is damped by a spring;

FIG. 13 is a simplified schematic illustration of the piston and of the chimney used in the folding step, for an alternative embodiment wherein the chimney bears a friction part;

FIG. 14 is a simplified schematic illustration of a diaphragm used for maintaining the free edge of the shell in position before sealing;

FIGS. 15 and 16 are schematic sectional views of two alternative embodiments of the wrapping sheet for the cheese portions of FIGS. 2 and 3;

FIG. 17 is a schematic illustration of a sheet before folding, adapted for a portion with parallelepipedal geometry; and

FIG. 18 is a sectional schematic illustration of the shell after folding and before filling.

### DETAILED DESCRIPTION:

### Steps of the Method

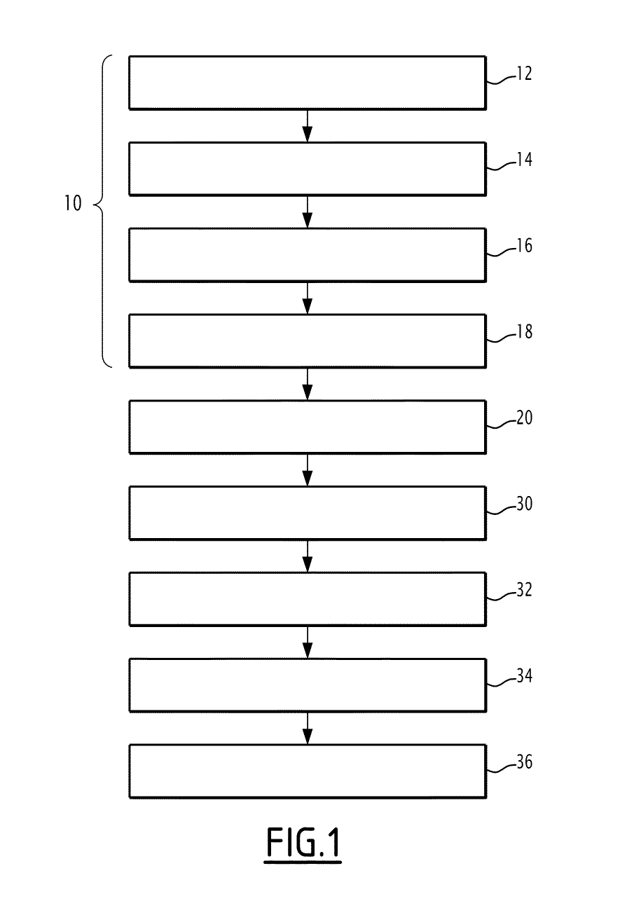

The method, the flowchart of which is illustrated in FIG. 1, includes at least:
one step 10 for providing a sheet comprising at least one paper layer;
one step 20 for folding the sheet, during which at least one first fold is formed in the sheet, the latter adopting the shape of a hollow shell with a bottom and a sidewall separated from the bottom by the first fold;
one step 30 for filling the shell, by casting cheese into said shell.

Typically, at least one second fold is formed in the sheet during the folding step 20, the second fold dividing the sidewall into several faces and absorbing the excess material resulting from the folding.

The method typically includes, additionally:
a step 32 for depositing a lid on the cheese;
a step 34 for folding a free edge of the shell towards the lid, generating at least one third fold between the sidewall of the shell and said free edge of the shell;
a step 36 for sealing the free edge of the shell with the lid.

More specifically, the step 10 for providing the sheet includes:
a sub-step 12 for unwinding a spool from a film in which the sheet will be cut out;
optionally a sub-step 14 for cutting and adhesively bonding an opening strip or a film in polymer at the surface of said film;
optionally a sub-step 16 for depositing a label in the area of the spool intended to form the sheet after cutting,
a sub-step 18 for cutting out the sheet in the film.

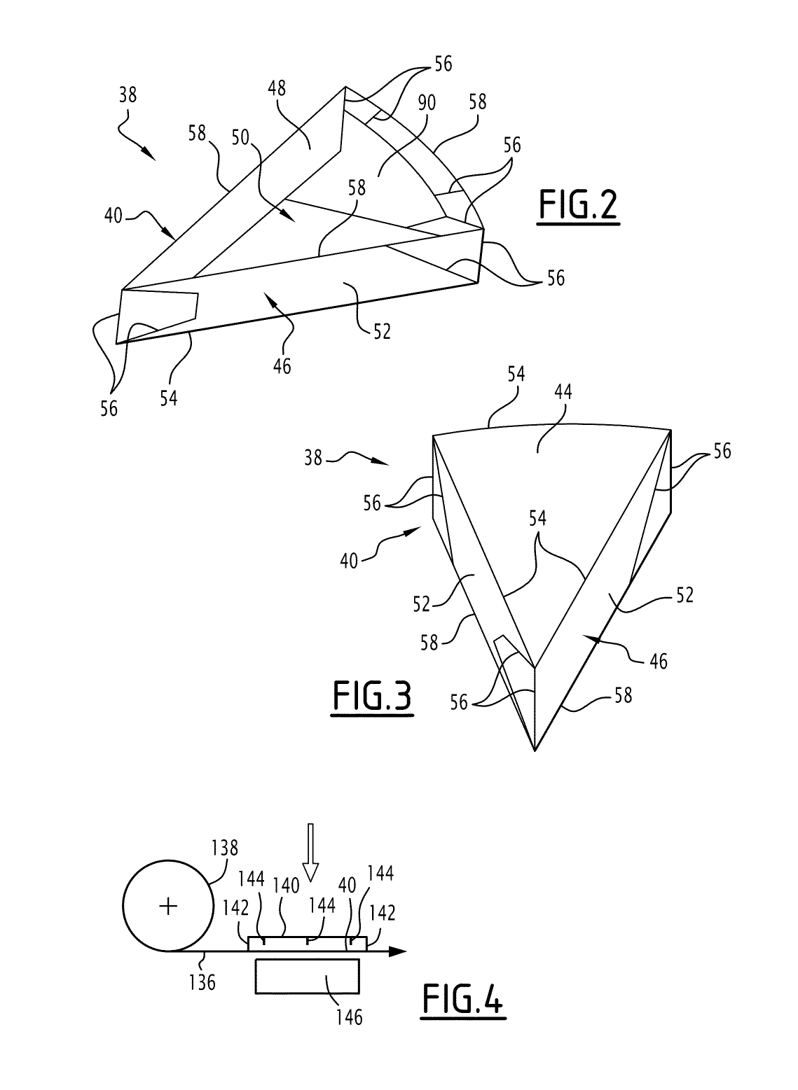

The cheese portion 38, obtained at the end of the method illustrated in FIG. 1 appears in FIGS. 2 and 3. It includes a wrapping sheet 40 and a dose of cheese (not visible) wrapped in the sheet 40. From these figures, it emerges that the sheet 40 is folded as a shell, so as to define an upper bottom 44, and a sidewall 46. The free edge 48 of the sidewall is folded back opposite to the upper bottom 44 and forms with the lid, a lower bottom 50. The lid 90, in FIG. 2 is partly hidden by the edge 48.

In the illustrated example, the upper and lower bottoms are triangular. The sidewall 46 includes three faces 52. It connects the lower and upper bottoms to each other.

The upper bottom 44 is separated from the sidewall 46 by first folds 54. In the illustrated example, the portion has three first folds 54. The different faces 52 of the sidewall 46 are separated from each other by the second folds 56. In the illustrated example, the portion has three second folds 56.

The free edge 48 is separated from the sidewall 46 by third folds 58. In the illustrated example, the portion has three second folds 58.

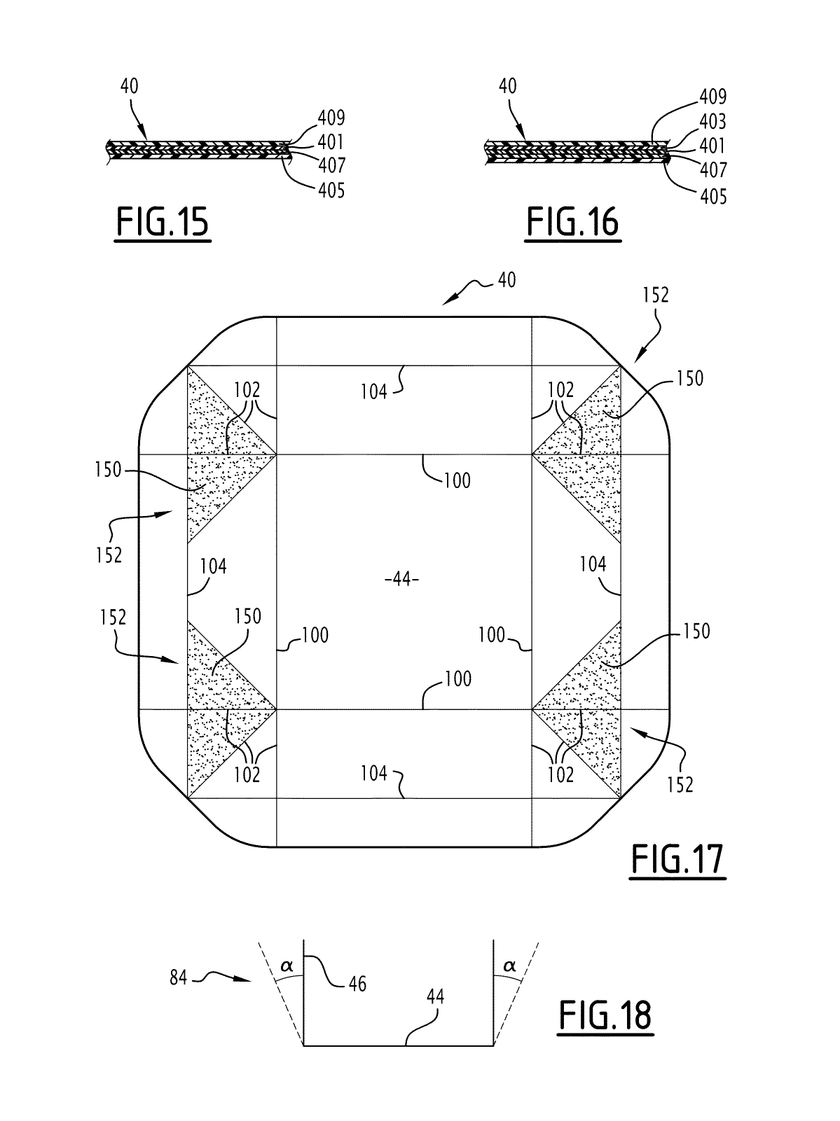

In the invention, the sheet 40 includes a paper layer 401 (FIGS. 15 and 16), instead of and in place of the aluminum layer used in the sheet of the state of the art. The paper layer 401 has an internal face turned towards the cheese and an external face opposite to the cheese. The sheet 40 also includes:

a low temperature sealing layer 405,

at least one waterproof layer 407 interposed between the internal face of the paper layer 401 and the sealing layer 405, and

at least one waterproof external layer 409 covering the external face of the paper layer 401.

### The Paper Material

As regards a material which will have to be substituted for aluminum for a cheese portion, thin paper is selected, the use of cardboard cannot be contemplated for this application. Therefore a paper with a thickness of less than 150 μm, and preferentially comprised between 20 and 50 μm is preferably selected. A paper suitable for contact with food is selected, preferably a paper with virgin fibers, and preferentially with a ventilated structure (moderate calendaring) in order to have better folding capability.

Paper material is very interesting for the substitution of aluminum of melted cheese portions, since paper is one of the rare materials with aluminum which actually preserves the folds made on the latter: Paper has good folding memory, giving the possibility of contemplating mechanization similar to that used for the sheet with an aluminum layer.

The paper, because of its fibrous nature also has good mechanical strength in traction and better behavior than thin aluminum giving the possibility of contemplating a reduction of the cracks on the stressed areas (friction in the folding chimney, folds, friction area in the sheath etc. . . . )

### The Sealing Layer

The sealing layer 405 is adapted for allowing sealing of the shell on itself and/or with the lid. The sealing is ensured by a layer of polymers, or by a lacquer or varnish (for example: polyethylene and its derivatives, vinyl lacquer, acrylic lacquer, nitrocellulose lacquer etc. . . . ). Ideally, the sealing temperature is less than 80° C., and preferentially less than 70° C., which gives the possibility of ensuring sealing by putting to use the heat released by the cheese. This coating is for example applied on the internal face of the paper layer of the shell, and on the external face of the lid (in contact with the shell). Alternatively, as illustrated in FIG. 7, the coating allowing the sealing is applied on the internal face of the lid. The external face of the lid in this case is preferably sealable on itself.

In an exemplary embodiment, the coating ensuring the sealing also ensures the waterproofness of the paper layer.

### Example of Possible Layers/Treatments:

In the examples of FIGS. 15 and 16, the waterproof layer 407 is obtained by a treatment carried out according to one or several of the following methods.

The application on the internal face of a layer 405 of a lacquer. Ideally the application is carried out in several layers, at least 2, from 2 to 20 μm, and more advantageously from 2 to 15 μm and still more advantageously from 2 to 10 μm. For example lacquers of an acrylic nature (methacrylate, acrylate, copolymer of these polymers with ethylene), of a nitro-cellulose, vinyl (PVC, PVacetate, PVLaurate, PVDC) nature, optionally added with fumaric acid, maleic acid, for example as an emulsion or a latex. Alternatively, the lacquer is applied on the external face of the paper layer.

The application on the internal face of a layer 405 of a varnish, for example of an acrylic, methacrylic, iso-cyanate, poly iso-cyanate, polyurethane, epoxy nature. Alternatively, the varnish is applied on the external face of the paper layer.

The application on the internal face of a plastic film 405 from 2 to 50 μm, and more advantageously from 2 to 20 μm and still more advantageously from 2 to 10 μm, for example produced by complexation of a film or direct coating/extrusion onto the paper. This film may be of the polyolefin type such as PE (polyethylene), PP (polypropylene), PB-1 (poly butylene 1), COC (copolymer of cyclic olefins); of the polyester type such as PET (polyethylene terephthalate), PEN (polyethylene naphthalate), PBT (Polybutylene terephthalate), PBA (polybutylene adipate), PBS (polybutylene succinate) PVac (polyvinyl acetate), PLA (polylactic acid), PHA (polyhydroxy alkanoates); of the styrene type such as PS (polystyrene) and copolymers thereof; of the vinyl type such as PVC (polyvinyl chloride), PVDC (poly-vinylidene chloride), PEF (polyethylene furane), PA (polyamides), EVOH (ethylvinyl alcohol), PVOH (polyvinyl alcohol). This plastic layer may receive a treatment of the metallization, coating, SiOx plasma type.

The waterproof external layer 409 is obtained by one or several of the treatments described above for the layer 407.

Moreover, the seal of the internal side of the paper layer 401 may be reinforced with a treatment carried out according to one or several of the following methods.

Carrying out a surface treatment of the internal face of the paper layer 401. This treatment may assume the form of chemical grafting such as the grafting of a fatty acid (for example acyl chloride or lauric acid). This surface treatment may also be a chemical treatment, for example with sulfuric acid in order to obtain a so called sulfurized paper, or by a product based on silicone, or by a fluoride. Finally, the treatment of the paper may be of the mechanical type such as calendaring or embossing. The external face of the paper layer may alternatively be also subject to the same treatment, for protecting the cheese portion from an outdoor potentially detrimental environment (a very humid refrigerator).

Carrying out a sealing treatment in the bulk of the paper layer 405. A silicone-based product, and/or a fluoride is dispersed in the paper in a selected mass proportion relatively to the paper in order to make the paper layer waterproof.

The various methods above may be used separately or as a combination.

### Supporting Layer:

In the example illustrated in FIG. 16, the sheet 40 further includes a support layer 403, interposed between the external face of the paper layer 401 and the waterproof external layer 409. The supporting layer 403 is for example a layer of plastic material, notably polyamide, polyethylene, OPP, PET etc. applied by extrusion or by lamination of a film. It imparts suitable mechanical strength to the sheet, notably towards sliding against the mechanical elements of the machine and during the folding. This layer also gives the possibility of protecting the paper sheet from direct contact with the mechanical elements which may deteriorate its surface aspect, notably by dirtying it. This layer may also be used for adding characteristics allowing preservation of the cheese portion over a long period, thus a gas barrier material, for example EVOH may be included in this layer, in order to adapt the perviousness to the preservation constraints of the packaged product.

According to an alternative not shown, the waterproof external layer and the supporting layer of a single and same layer, made in the same material. This material in this case is a plastic material layer, notably in polyamide, polyethylene, OPP and PET etc. applied by extrusion or lamination of a film.

According to another alternative not shown, the wrapping sheet includes an additional barrier layer between the internal face of the paper layer and the water barrier layer. This additional barrier layer gives the possibility of preserving the cheese portion over a long period, and it may include a gas barrier material, for example EVOH, in order to adapt the permeability to the preservation constraints of the packaged product.

The different materials making up the sheet may be added with a filler (in the form of powders, fibers), with pigments or coloring agents so as to optionally color the structure, with a plasticizer for modifying the properties of the polymers used and notably providing flexibility, with a slip agent for adapting to the constraints upon passing through a machine.

### Paper/Plastic Layers Proportion.

The thicknesses of the polymers, lacquers or varnishes added onto the paper, are sufficiently small and so as not to degrade the folding memory of the paper. Ideally the paper proportion (in thickness) in the sheet will be greater than 30%, preferentially greater than 50%. The polymers Incorporated into the sheet are totally or partly from a renewable origin, which in this case gives the possibility of proposing an alternative in majority of renewable origin, to the wrapping sheet of the state of the art.

The sheet is therefore typically in a multilayer material, the combination of the materials being selected so as to form a substantial humidity barrier and, depending on the packaged cheese, suitable barriers to light, to gases and to fragrances.

### Opening System

In order to proceed with the opening of the portion, an opening system is provided. It typically includes, like in the portions made with an aluminum sheet, at least one thin strip of a sufficiently resistant material, laminated on the sheet inside the portion. The strip gives the possibility of forcing the tearing of the sheet or of the sealing area of facing the strip. Conventionally, these strips may be made with a polymeric material of the PET or PP type, but also with other types of polymers appearing as a film and sufficiently resistant. It is also possible to use paper material strips.

The resistant material strip which may cause tearing of the sheet may also be contemplated as directly incorporated into the thickness of the multi-layer sheet during its manufacturing, between the layers for example.

This type of opening system, conventionally used on aluminum portions is commonly designated as Tircel (registered name by Rexor) or Tear Stripe.

In the cases of opening solutions requiring weakening of the structure, it is ensured that the protective layers of the paper are not deteriorated, the methods are notably preferred which allow this operation to be carried out before applying the protective layers.

Finally, it is also possible with a geometry different from the one used for aluminum portions, to use a material associated with a geometry allowing opening by peeling.

In every case, the grasping area for opening may consist both of a portion of the film forming the portion by means of specific folding and an added part (tircel overhang, addition of labels, sealing a grasping tab, etc. . . . ).

### Lid

The lid 90 typically has the same structure and consists of the same materials as the sheet 40, with a single difference: the sealing layer covers the waterproof external layer and not the waterproof layer.

### Humidity Absorption in the Lid

Particular care is taken as to the possibility of humidity absorption by the edge on the lid. The paper is thus hydrophobicized in the bulk by one of the methods mentioned earlier. Another method for solving this problem is to produce a shell-lid assembly avoiding that the edge of the material at the shell and/or at the lid is exposed to direct contact with the cheese. The layout illustrated in FIG. 7 gives the possibility of solving this problem. The lid is larger than in the traditional aluminum portions, allowing it to be folded back on its edges and having it move upwards along the shell. After closing the portion, there is no contact between the edge of the lid and the product.

### Examples of Structures for the Wrapping Sheet and the Lid

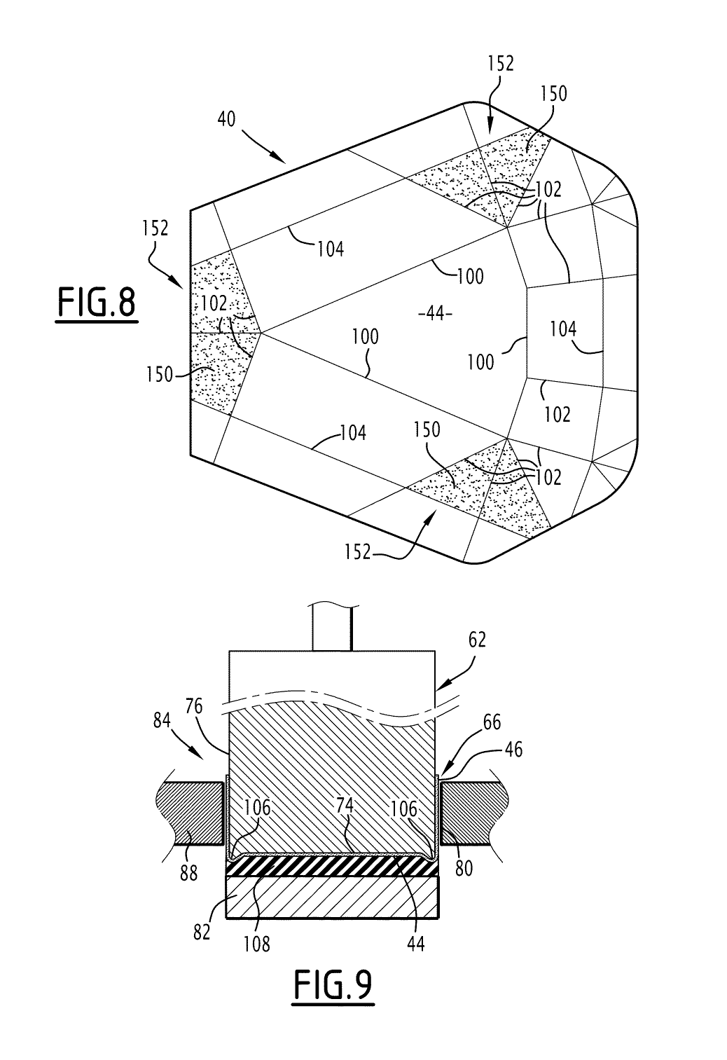

The successive layers, for five examples of sheets, are listed below, from the cheese to the outside of the portion.
Example 1: vinyl lacquer 2-6 μm/extruded PE film 6-12 μm/coated paper 30-40 g/m²/print/acrylic varnish 2-6 μm
Example 2: nitrocellulose lacquer 2-6 μm/extruded PE film 6-12 μm/coated paper 30-40 g/m²/print/acrylic varnish 2-6 μm
Example 3: vinyl lacquer 2-6 μm/extruded PE film 6-12 μm/coated paper 30-40 g/m²/print/acrylic varnish 2-6 μm/cold adhesive marked on FIGS. 8 and 17 with reference 150.
Example 4: vinyl lacquer 2-6 μm/laminated PET film stuck on the paper 6-12 μm/coated paper 30-40 g/m²/print/acrylic varnish 2-6 μm
Example 5: low temperature sealing polymer (PE derivative) extrusion/extruded PE film 6-12 μm/coated paper 30-40 g/m²/print/acrylic varnish 2-6 μm

The successive layers, for 5 examples of lids, are listed below, from the cheese to the outside of the portion of the examples below are adapted to the cases when the edge of the lid has exposed paper in contact with the cheese:
Example 1: PE extrusion 6-12 μm/sulfurized paper 20-40 g/m²/vinyl lacquer 4-8 μm
Example 2: PE extrusion 6-12 μm/sulfurized paper 20-40 g/m²/vinyl lacquer 2-6 μm/vinyl lacquer 2-6 μm
Example 3: lamination of a PET film 6-12 μm/sulfurized paper 20-40 g/m²/vinyl lacquer 4-8 μm
Example 4: PE extrusion 6-12 μm/sulfurized paper 20-40 g/m²/vinyl lacquer 4-8 μm
Example 5: PE extrusion 6-12 μm/paper treated in the bulk with a fluorinated waterproofing agent 20-40 g/m²/vinyl lacquer 4-8 μm

The successive layers, for three other examples of lids, are listed below, from the cheese to the outside of the portion. The examples below are adapted to the cases when the lid has the illustrated geometry in FIG. 7 (lid running upwards on the edges of the shell, no paper in direct contact with the cheese), and wherein a treatment of the paper in the bulk is not necessary.
Example 1: PE extrusion 6-12 μm/coated paper 20-40 g/m²/vinyl lacquer 4-8 μm
Example 2: PE extrusion 6-12 μm/coated paper 20-40 g/m²/vinyl lacquer 2-6 μm/vinyl lacquer 2-6 μm
Example 3: lamination of a PET film 6-12 μm/coated paper 20-40 g/m²/vinyl lacquer 4-8 μm

### Manufacturing Method

Grooving with Cutting Out

The substeps 12 and 18 are illustrated in FIG. 4. The film 136 is unwound the from the spool 138. A knife 140, bearing blades 142, the cuts outs the sheet 40 in the film 136. The knife 140 further bears grooving fillets 144. When the knife 140 is lowered without deforming the film, the grooving fillets 144 pinch the sheet 40 against a fixed support 146. The pattern of the grooving fillets 144 corresponds to that of the folding lines of the sheet 40.

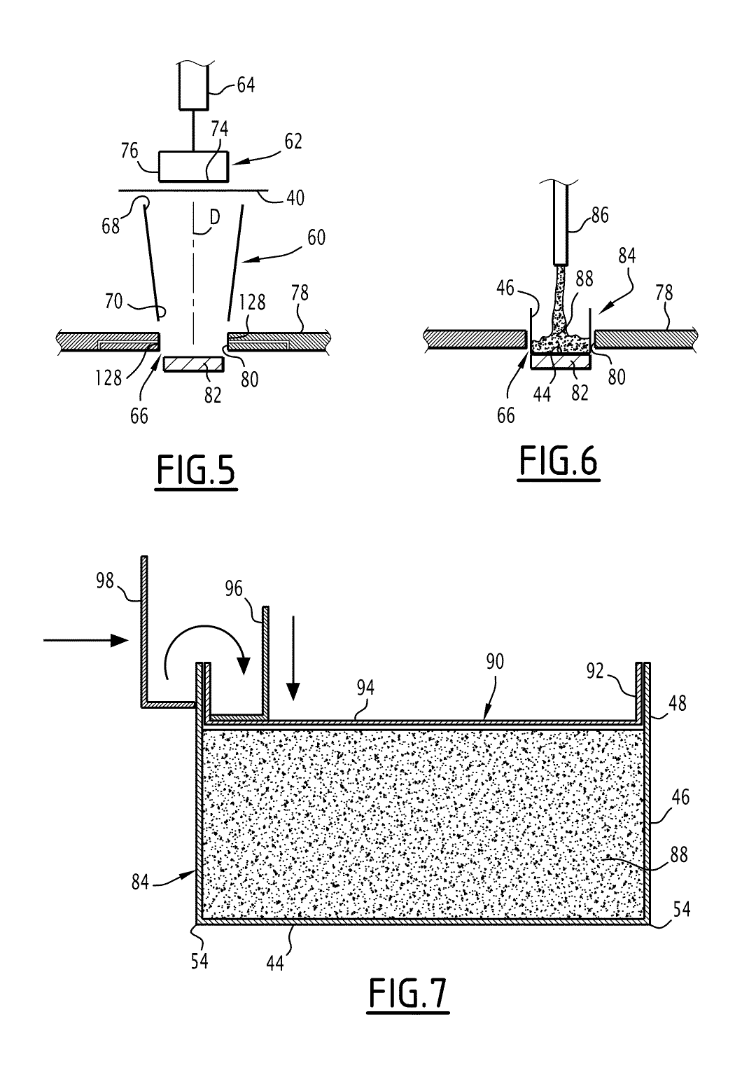

The folding step 20 is carried out as schematically illustrated in FIG. 5.

### Producing the First and Second Folds

Step 20 applies a folding chimney 60, a piston 62, an actuator 64 laid out for displacing the piston 62 through the chimney 60, and a cell 66 for receiving the hollow shell obtained at the end of the folding step. The chimney 60 includes a peripheral wall delimiting an upstream aperture 68 and a downstream aperture 70. It's consists of a plurality of blades partly visible in FIG. 12. The blades 72 are laid out in order to generate the first and second folds 54 and 56 when the sheet 40 is displaced through the chimney, from the upstream aperture 68 to the downstream aperture 70, or by the piston 62. Such a chimney, notably the layout of the blades 72 and giving the possibility of obtaining the folds 54 and 56, is known per se and will not be described in detail here.

The piston 62 includes a front face 74 intended to come into contact with the sheet 40 and to push the latter through the chimney. The front face 74 substantially has the shape of the bottom 44 of the shell. The piston 62 further includes a side surface 76, against which the sidewall 46 of the shell is folded back when the sheet 40 passes through the chimney. The front face 74 in the illustrated example is substantially perpendicular to the direction D.

The actuator 64 is a linear cylinder displacing the piston 62 along a direction D materialized in FIG. 5, corresponding to the central axis of the chimney 60.

The cell 66 is made in a carousel 58, which includes a large number of cells of the same type like the one illustrated in FIG. 5. The carousel 78 is laid out for displacing the cell 66 from one station to the other, and notably a first station for receiving the hollow shell obtained at the end of the step for folding the sheet, to a second station at which is carried out the step 30 for filling the shell; and then to a third station at which is carried out the step 32 for removing the lid, a fourth station at which is carried out the step 34 for folding the free edge towards the lid, and a fifth station at which is carried out the step 36 for sealing the free edge on the lid.

The cell 66 is placed under the downstream orifice 70 of the chimney. It is open towards this orifice. It is delimited by a peripheral wall 80 and by a pad 82 forming the bottom of the cell 66.

The folding step 20 is carried out by placing the sheet 40 facing the upstream orifice 68 of the chimney 60, in an orientation substantially perpendicular to the direction D. The piston 62 via the front face 74 will bear upon the area of the sheet 40 intended to form the bottom 44. The cylinder 64 pushes the piston 62 and the sheet 40 through the chimney 60. The blades 72 are laid out so as to fold the sheet 40 gradually as the piston 62 moves along the chimney. The first and second folds 54 and 56 are thus generated, the sheet adopting the shape of a hollow shell, notably visible in FIG. 5.

The piston 62, when the sheet exits the chimney 60, pushes the latter as far as into the cell 66.

As illustrated in FIG. 16, the sidewall 46, after step 24 for folding the sheet 40 and before casting the cheese into the shell 64, forms with the bottom 44 an angle of substantially 90°, with a possible outward relaxation a of at most 15°, preferably less than 5°, still preferably less than 1°. Indeed, after the shell 84 has exited the chimney 60, the angle formed between the sidewall and the bottom tends to slightly open, this phenomenon being called a relaxation. Because the sheet 40 has weakening along the lines intended to form the first folds 54 (as described later on), and/or that the first folds 54 have undergone squeezing, the relaxation does not exceed 15°. The angle between the sidewall and the bottom does not increase by more than 15°.

### Filling

FIG. 6 illustrates the step for filling the shell 84 with the cheese. The shell 84 rests via the bottom 44 on the pad 82, the sidewall 46 being located against or in close proximity to the wall 80 of the cell. The carousel 78 places the shell 84 under an orifice through which flows the cheese 88.

In the illustrated example, the cheese 88 is melted cheese, hot-flowing inside the shell 84.

### Putting on the Lid and Producing the Third Folds

The step 34 for folding the free edge of the shell towards the lid is illustrated in FIG. 7. The shell filled with cheese was displaced by the carousel 78 as far as the corresponding station. The shell 84 is again found in the cell 66, the carousel 78 and the cell 66 not being illustrated in FIG. 7.

On the other hand, the lid 90 is illustrated, laid on the free surface 91 of the cheese. The lid 90 initially has the shape illustrated in FIG. 7. Its edge 92 is raised around the central portion 94, and extends facing the free edge 48 of the shell. Interior fingers 96 maintains the lid 90 flattened against the cheese. Several interior fingers 96 are distributed over the periphery of the lid 90. The fingers 96 each have a bent end which presses the raised edge of the lid 90 against the sidewall 46 of the shell. Other exterior fingers 98 are distributed around the shell 80 at least facing the interior fingers 96. The exterior fingers 98 will radially bear against the free edge 48 of the shell. They substantially move parallel to the lid, i.e. substantially parallel to the free surface 91 of the cheese from the outside to the inside of the shell. Under the effect of this constraint, the free edge 48 and the raised edge are folded back towards the central portion 94 of the lid. The interior fingers 96 are thus disengaged by a radial movement towards the center of the lid. Third folds 58 are thus generated, substantially at the free surface of the cheese or slightly above the latter.

### Marking the Folds

Several arrangements are applied in the method described above so as to ensure that the first, second and third folds 54, 56, and 58 are well marked, and so that the sheet 40 does not tend to unfold after shaping. These arrangements are used individually or as a combination.

### Weakening

As illustrated in FIGS. 8 and 17, the sheet 40 may include weakening points along the lines 100, 102, 104 intended to form the first, second and third folds. The position of the weakening points depends on the shape of the sheet and on the shape of the cheese portion. The sheet 40 illustrated in FIG. 8 is intended for manufacturing a portion with a triangular bottom, like the one illustrated in FIGS. 2 and 3. For a portion having a rectangular parallelepipedal shape, the sheet 40 is rectangular as illustrated in FIG. 17.

In the illustrated example the weakening points 100, 102, 104 are achieved by pressing the sheet 40 between the grooving fillets 144 and a support and 46 along the folding lines, as explained above, in connection with FIG. 4.

### First Folds

In the alternative illustrated in FIG. 9, the weakening 100 is generated along the lines 100 intended to form the first folds 54 by providing a grooving fillet 106 around the front face 74 of the piston. When the piston 62 pushes the shell 84 into the cell 66, the grooving fillet 106 will press the edges of the bottom 44 against the pad 82.

In this case, the pad 82 preferably includes a rubber surface 108 into which the grooving fillet 106 will sink.

In another embodiment not shown, the pad 82 includes a hollow groove into which the grooving fillet 106 is received.

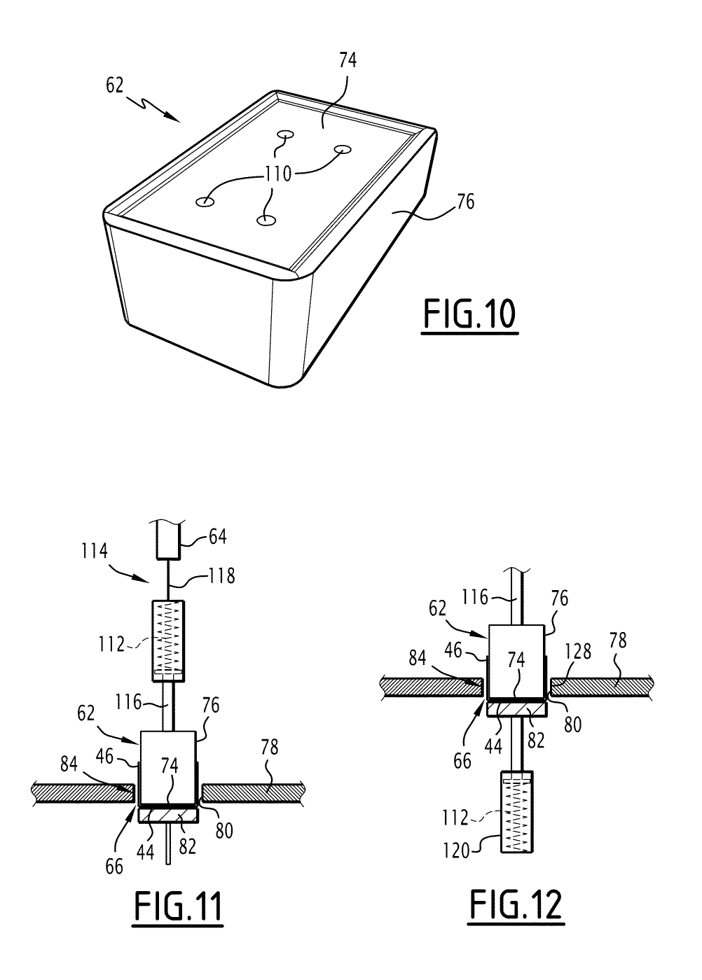

As illustrated in FIG. 10, another means for obtaining well marked first folds 54 is to provide a plurality of suction holes 110 on the front face 74 of the piston 62. Four suction holes are illustrated in FIG. 10, but the number of holes 110 may be different, smaller or greater depending on the needs. The holes 110 are fluidically connected to a suction member such as a vacuum pump (not shown). At the inlet of the chimney 60, the sheet 40, and more specifically the bottom 44 of the sheet is maintained flattened against the front face 74 of the piston by suction through the holes 110, which is expressed by folds of better quality. Another solution for marking the first folds is to provide that the piston 62 strongly presses the bottom 44 of the shell against the pad 82. This is achieved by adjusting the stroke of the piston 62.

In FIG. 10, the front face 74 is rectangular. Such a piston is adapted for manufacturing portions with the shape of rectangular parallelepipeds. For portions with triangular bottoms, such as the one illustrated in FIGS. 2 and 3, the front face 74 is triangular.

In the alternative embodiment illustrated in FIG. 11, a spring 112 is interposed between the piston 62 and the cylinder 64 so as to damp the squeezing of the first folds. More specifically, the piston 62 is connected to the cylinder 64 via an actuation rod 114, including a segment 116 secured to the piston 62 and a segment 118 displaced by the cylinder 64. The spring 112 is interposed between the portions 116 and 118. Thus, as explained above, the piston 62 is displaced via the cylinder 64 until it abuts against the pad 82. If the stroke of the cylinder 64 is poorly adjusted, the piston 62 will abut before the cylinder 64 is at its end of travel. The excess travel is absorbed by compressing the spring 112. This has the effect of strongly compressing the sheet 40 against the pad 82, below which is favorable for marking the first folds.

In the alternative embodiment of FIG. 12, the spring 112 is not interposed between the piston 62 and the cylinder 64 but between the pad 82 and a fixed support 120. In this case, the pad 82 has at least one degree of freedom with respect to the wall 80, along with the compression axis of the spring 112. The compression axis of the spring 112 corresponds to the displacement direction of the cylinder. If the piston comes into contact with the pad 82 before the end of travel of the cylinder, the excess travel is absorbed by sinking of the pad 82, against the return force of the spring 112.

### Second Folds

In order to allow proper marking of the second folds 56, provision is made for reduction of the play between the blades 72 of the chimney 60, so as to pinch the second folds 56 formed upon passing of the sheet 40 through the chimney 60. Also, the play between these blades 72 and the sidewall 76 of the piston may be reduced, in order to mark these second folds 56.

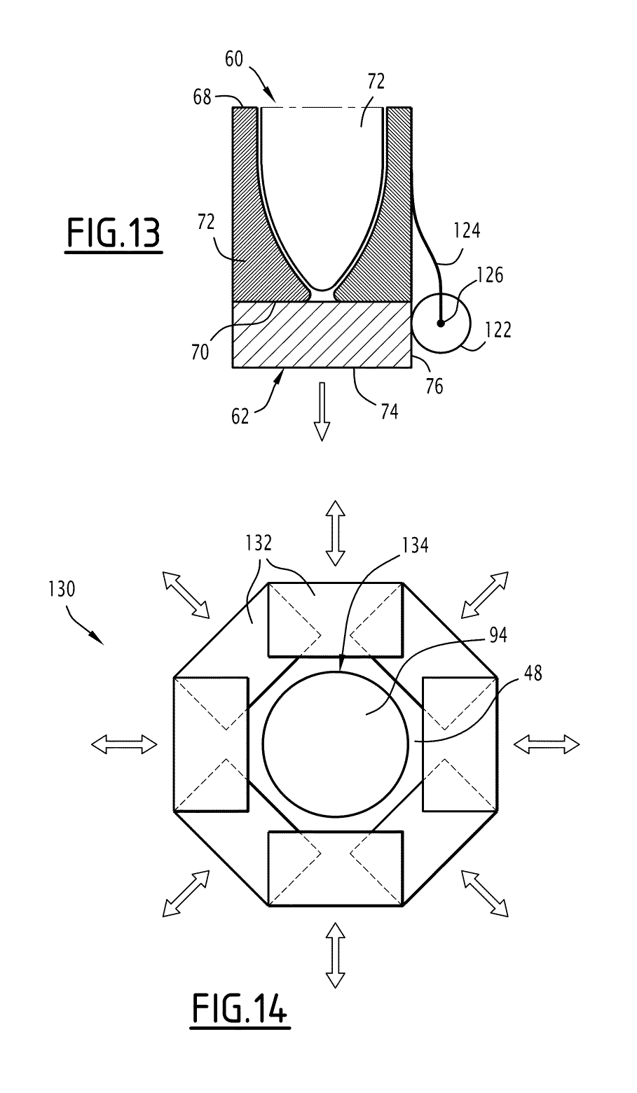

In the alternative illustrated in FIG. 13, the chimney 60 is equipped with several friction parts 122, each bound to the chimney 60 through an elastic member 124 urging the friction part 122 against the piston 62 when the latter crosses the chimney 60. In the illustrated example, each friction part 122 is a roller, bound through a pivot connection 126 to the elastic member 124. The roller 122 is placed slightly under the downstream orifice 70 of the chimney. The elastic member 124 is for example a leaf spring, one end of which is rigidly attached on the peripheral wall of the chimney 60, and the opposite end of which bears the pivot connection 126. The spring 124 returns the roller 122 to a rest position in which one portion of the peripheral edge of the roller is located at right angles to the downstream orifice 70. In other words, if the projection of the roller 122 is considered parallel to the direction D in the plane of the downstream orifice 70, a portion of the roller is found inside the downstream orifice 70.

The axis of rotation of the pivot connection 126 is perpendicular to the direction D.

When the piston 62 bearing the shell exits the downstream orifice 70, it displaces each roller 122 towards the outside of the chimney against the return force of the spring 124. The rollers 122 are positioned circumferentially around the chimney 60, at angles corresponding to the positions of the second folds 56. The rollers 122 roll on the second folds gradually as the piston moves down towards the cell 66. This causes the squeezing of the second folds.

### Vacuum Holes in the Cell

In an alternative embodiment illustrated in FIG. 5, the wall 80 of the cell includes suction orifices 128, fluidically connected to a suction member of the vacuum pump type. The orifices 128 are provided for applying vacuum once the shell is in position in the cell 66, preventing the second folds from unfolding after the shell has left the chimney 60. This contributes to proper formation of the second folds.

### Third Folds

In order to promote marking of the third folds, provision is made for reducing the play between the interior finger 96 and the exterior finger 98, this play being taken along a direction perpendicular to the free surface of the cheese.

In an alternative embodiment illustrated in FIG. 14, a diaphragm is positioned above the cell 66, at the sealing station. The diaphragm 130 is provided for maintaining the free edge 48 of the shell in position between the step for folding towards the lid and the sealing step. Indeed, at the end of the step for folding the free edge of the shell, this free edge is tilted towards the center of the shell, and forms a reduced angle with the central portion 94 of the lid. For example, this angle is of the order of 30°. The diaphragm 130 gives the possibility of maintaining the free edge 48 in this position, until the sealing operation. The diaphragm 130, as illustrated in FIG. 14 includes a plurality of plates 132 each radially displaceable between a position relatively further away from the center of the lid, and a relatively closer position to the center of the lid. When the plates 132 are in a closer position to each other, they form a crown delimiting a central empty space 134. The crown is located immediately above the folded-back free edge 48, and prevents the latter from raising itself by unfolding the third folds 58.

The diaphragm of FIG. 14 is adapted for a cheese portion with a cylindrical or octagonal in shape stop it may be laid out so as to adapt to a cheese portion with a triangular, rectangular, square geometry or with any other geometry.

In the sealing step, a heating member is brought closer to the free edge 48, from the top. The plates 132 are then displaced to their retracted position so as to allow the heating member to move down, which may catch without any difficulty the free edge 48 and press the latter against the central portion 94 of the lid.

### External Adhesive of the Portion

According to an alternative embodiment of the invention, the sheet 40 includes an adhesive 150 on the marked areas 152 intended to form the second folds 56. The adhesive 150 is illustrated as shaded in FIGS. 8 and 17.

The adhesive 150 is placed on the external face of the sheet 40 in order to avoid any contact with the cheese. The adhesive 150 is a tacky product mechanically reactivatable by pressing on the sheet.

The adhesive 150 is deposited inside the second folds 56 in order to maintain the latter flattened against the shell 84. This limits the risks of opening of the portion by a spring effect of the sheet.

1-25. (canceled)

26. A fresh, melted fresh or thermized fresh cheese portion comprising:
a wrapping sheet having a basis weight comprised between 20 to 50 g/m² folded as a hollow shell, with a bottom and a sidewall separated from the bottom by a first fold;
a cheese dose wrapped in the sheet, the cheese being hot-cast between 70° C. and 85° C. in the liquid or viscous state in the shell;
a lid, tightly sealed to the shell, the cheese portion not comprising any dead space;
wherein the sheet does not include any aluminum layer, the sheet including at least one paper layer having an internal face turned towards the cheese and an external face opposite to the cheese, a low temperature sealing layer, at least one waterproof layer interposed between the internal face of the paper layer and the sealing layer, and at least one waterproof external layer covering the external face of the paper layer.

27. The portion according to claim 26, wherein the cheese is cast into the shell at a casting temperature, the sealing layer sealing the shell to the lid having a melting temperature comprised between the casting temperature +10° and the casting temperature −10°.

28. The portion according to claim 26, wherein the portion includes an opening system arranged to cause the opening of the wrapping sheet when the opening system is actuated by a user.

29. The portion according to claim 26, wherein the lid is an area of the sheet.

30. The portion according to claim 26, wherein the lid is not an area of the sheet and includes at least one paper layer having an internal face turned towards the cheese and an external face opposite to the cheese, at least one waterproof layer covering the internal face, and at least one waterproof external layer covering the external face.

31. The portion according to claim 26, wherein the sheet has a first thickness, the paper layer having a second thickness greater than 30% of the first thickness, preferably greater than 50% of the first thickness.

32. The portion according to claim 26, wherein the internal face of the paper layer bears a chemical graft of a fatty acid.

33. The portion according to claim 26, wherein the internal face of the paper layer has undergone a chemical surface treatment to provide a seal.

34. The portion according to claim 26, wherein the paper layer has undergone a bulk treatment to provide a seal and contains a product based on silicone, and/or a fluoride dispersed in the paper in a mass proportion relatively to the papers selected to make the paper layer waterproof.

35. The portion according to claim 26, wherein the waterproof layer and/or the waterproof external layer comprises at least one from a waterproof lacquer layer, from a waterproof varnish, from a plastic material layer.

36. The portion according to claim 26, wherein the waterproof layer and the sealing layer are a single and same layer consisting of a same material.

37. A method of manufacturing a cheese portion according to claim 26, the method comprising at least:
one step of supplying the wrapping sheet;
one step of folding the sheet, during which at least one first fold is formed in the sheet, the latter adopting the shape of a hollow shell with a bottom and a sidewall separated from the bottom by the first fold;
one step of filling the shell, by casting the cheese into said shell, preferably at a temperature comprised between 70° C. and 85° C.;
the method further comprising a step of weakening the sheet along at least one line intended to form the first fold, and/or squeezing at least the first fold, the weakening and/or the squeezing being achieved preferably without heating the sheet.

38. The method according to claim 37, wherein, during the folding step, at least one second fold is formed in the sheet, the second fold dividing the sidewall into several faces, the method comprising a step of weakening the sheet along at least one line intended to form at least the second fold, and/or squeezing of at least the second fold, the weakening and/or the squeezing being achieved without heating the sheet.

39. The method according to claim 38, wherein the step of folding the sheet is carried out by pushing the sheet by a piston through a folding chimney, the piston having a front face and a side surface, the front face being in contact with the sheet and having a shape identical with that of the bottom, the chimney having a plurality of blades laid out for producing the first and second folds and pushing back the sidewall of the shell against the side surface of the piston.

40. The method according to claim 39, wherein the squeezing of the first fold is achieved by urging the sheet by the piston inside a cell.

41. The method according to claim 40, wherein the squeezing of the first fold is damped by a spring interposed between the piston and an actuator or between a pad making up the bottom of the cell and a fixed support.

42. The method according to claim 39, wherein the bottom of the shell is maintained flattened against the front face of the piston by applying a vacuum through said front face.

43. The method according to claim 39, wherein the squeezing of the second fold is achieved by pinching between blades of the chimney and/or by pinching between the blades of the chimney and the piston, and/or by a friction part bound to the chimney through an elastic member urging said friction part against the piston, the friction part being a roller for example.

44. The method according to claim 37, wherein the method comprises:
a step of depositing a lid on the cheese;
a step of folding a free edge of the shell towards the lid, at least generating a third fold between the sidewall of the shell and said free edge of the shell;
the method comprising a step of weakening the sheet along at least one line intended to form at least the third fold, and/or squeezing at least the third fold, the weakening and/or the squeezing being achieved without any heating.

45. A cheese portion obtained by the method according to the claim 37.
